(19) United States
(12) Patent Application Publication
(10) Pub. No.: US 2024/0113573 A1
(43) Pub. Date: Apr. 4, 2024

(54) AUTOMOTIVE ELECTRIC AUXILIARY UNIT AND METHOD FOR MANUFACTURING THE SAME

(71) Applicant: PIERBURG PUMP TECHNOLOGY GMBH, Neuss (DE)

(72) Inventor: ALEXANDER FINDEISEN, DOEBELN (DE)

(73) Assignee: PIERBURG PUMP TECHNOLOGY GMBH, Neuss (DE)

(21) Appl. No.: 18/265,680

(22) PCT Filed: Dec. 10, 2020
(86) PCT No.: PCT/EP2020/085504

§ 371 Date: Jun. 7, 2023

(51) Int. Cl. H02K 1/18; H02K 1/14; H02K 5/08; H02K 15/14; H02K 15/12

(52) U.S. Cl. CPC H02K 1/185; H02K 1/148; H02K 5/08; H02K 15/14; H02K 15/12

(57) ABSTRACT

An automotive electric auxiliary unit includes an electric motor. The electric motor includes a motor rotor which rotates about a rotor axis, a multi-piece motor stator having stator coils, stator teeth, and a separate ring-shaped magnetic back iron ring, and a plastic motor housing. The separate ring-shaped magnetic back iron ring radially surrounds the stator teeth and is attached to the stator teeth. The separate ring-shaped magnetic back iron ring is overmolded by the plastic motor housing.

### CROSS REFERENCE TO PRIOR APPLICATIONS

This application is a U.S. National Phase application under 35 U.S.C. § 371 of International Application No. PCT/EP2020/085504, filed on Dec. 10, 2020. The International Application was published in English on Jun. 16, 2022 as WO 2022/122157 A1 under PCT Article 21(2).

### FIELD

The present invention is directed to an automotive electric auxiliary unit.

### BACKGROUND

Automotive electric auxiliary units are not provided as traction engines, but are secondary devices such as, for example, vacuum pumps, liquid pumps or gas pumps. An automotive electric auxiliary unit is typically provided with an electric motor. Such an electric motor of an automotive electric auxiliary unit is described, for example, in EP 1 306 960 A2. The electric motor there comprises a rotatable motor rotor and a static motor stator. The motor stator comprises a main stator body which is provided with several stator teeth, wherein several stator coils are wound onto the stator teeth. To facilitate the production of the motor stator, it is known to configure the stator teeth separately, wind them separately first, and subsequently assemble them to form a closed stator. The stator may alternatively comprise a main stator body with several stator teeth, wherein the motor stator teeth are radially connected inside with the respectively adjacent stator teeth. The stator teeth may be wound from radially outside. After the stator coils have been wound, a separate ring-shaped magnetic back iron ring is set thereon so that the stator teeth comprise a magnetic connection radially outside.

The complete motor stator is typically fixed in a motor housing by screw joints or by an adhesive bonding. However, these fixation methods require additional fixation elements and/or a complex mounting process to attach the motor stator to the motor housing.

### SUMMARY

An aspect of the present invention is to provide an automotive electric auxiliary unit which can be fastened in a reliable and simple way.

In an embodiment, the present invention provides an automotive electric auxiliary unit which includes an electric motor. The electric motor includes a rotatable motor rotor which is configured to rotate about a rotor axis, a multi-piece motor stator comprising a plurality of stator coils, a plurality of stator teeth, and a separate ring-shaped magnetic back iron ring, and a plastic motor housing. The separate ring-shaped magnetic back iron ring is arranged to radially surround the plurality of stator teeth and is attached to the plurality of stator teeth. The separate ring-shaped magnetic back iron ring is overmolded by the plastic motor housing.

### BRIEF DESCRIPTION OF THE DRAWINGS

The present invention is described in greater detail below on the basis of embodiments and of the drawings in which:

FIG. 1 schematically shows a longitudinal section of an automotive electric auxiliary unit with an electric motor;

FIG. 2 shows a section of an automotive electric auxiliary unit with an electric motor of FIG. 1; and

FIG. 3 shows a perspective view of a motor housing and a motor stator of the electric motor of FIG. 1.

### DETAILED DESCRIPTION

The auxiliary unit according to the present invention is provided with an electric motor with a motor stator and a motor rotor. The motor stator is provided with a stator sheet pack of packed stator sheets and one or more motor stator coils generating an electromagnetic field interacting with a rotatable motor rotor. A rotor assembly is provided with a rotatable rotor body and a permanent magnet attached to the rotor body. The motor rotor directly or indirectly drives a mechanical element. The mechanical element is, for example, a pump rotor which is co-rotatingly fixed at the rotor body. The rotor assembly rotates around an axial rotor axis.

The stator comprises several stator teeth which are connected radially inside with the respectively adjacent stator teeth. The stator teeth are connected radially outside with each other by a separate ring-shaped magnetic back iron ring. When the ring-shaped magnetic back iron ring is detached, the stator teeth are accessible so that all the stator teeth can be wound.

The automotive electric auxiliary further comprises a motor housing which is made of plastic. The motor rotor and the motor stator are arranged inside the plastic motor housing. The motor rotor is rotatably attached to the motor housing via bearing elements. The motor stator is attached to the housing.

To simplify the production of the auxiliary unit, the separate ring-shaped magnetic back iron ring is overmolded by the plastic motor housing.

The overmolding of the magnetic back iron ring causes a form-fit connection between the magnetic back iron ring and the housing. A circumferential groove is created on an inner surface of the motor housing during the production of the motor housing and the overmolding of the magnetic back iron ring. The outer circumferential surface of the magnetic back iron ring is in contact with a bottom of the groove so that the magnetic back iron ring is radially fixed at the motor housing. Each axial end of the magnetic back iron ring is furthermore in contact with one flank of the groove so that the magnetic back iron ring is also form-fitted to the housing in axial direction. The motor stator is additionally form-fitted and/or materially bonded to the housing in rotation direction.

The first step in the manufacture of the electric motor is to wind the coils onto the stator teeth and to produce the housing. During the plastic housing production step, the magnetic back iron ring is overmolded by the plastic material of the plastic housing and is thus fixed to the plastic housing. The stator teeth with the wound coils are then inserted into the magnetic back iron ring and fixed to the magnetic back iron ring. Finally, the motor rotor is inserted into the stator.

This kind of manufacturing of the electric motor reduces the production effort, wherein the additional step in which the electric motor is attached to the housing is no longer required. It furthermore provides a reliable attachment of the motor stator to the housing.

In an embodiment of the present invention, the plastic motor housing can, for example, be produced by injection molding. Injection molding is a well-known process for manufacturing plastic components, wherein a thermoplastic material is liquefied and injected into an injection mold under pressure. Inside the mold, the material returns to its solid state through cooling or a cross-linking reaction and is removed as a finished part after opening the mold. The overmolding of an element is achieved by inserting the element into the injection mold, whereby the liquefied plastic flows around the element and forms a form-fit connection to the element in the cooled state.

In an embodiment of the present invention, the stator teeth can, for example, be attached to the separate ring-shaped magnetic back iron ring via a form-fit and/or via a force-fit connection. Both types of connection provide a reliable connection of the stator teeth to the ring-shaped magnetic back iron ring in a simple and cost-effective way.

In an embodiment of the present invention, the form-fit connection is a dovetail connection, wherein several dovetail-like protrusions are press-fitted into corresponding grooves, so that the stator teeth are form-fitted to the magnetic back iron ring in the radial and tangential direction and force-fitted or friction-fitted to the magnetic back iron ring in the axial direction. The dovetail-like protrusions and the corresponding groves provide a reliable fastening of the stator teeth at the magnetic back iron ring in radial direction.

During the manufacture of the electric motor, the ring is overmolded through the motor housing, and the stator teeth are then inserted axially into the magnetic back iron ring, whereby the dovetail-like protrusions are pushed axially into the grooves. The motor stator is therefore fixed to the housing only by injection overmolding of the ring and the axially inserting the stator teeth into the ring. This reduces the mounting effort of the stator on the motor housing.

In an embodiment of the present invention, the stator teeth can, for example, be attached to each other by a plastic member. The plastic member is ring-shaped and connects the stator teeth on the radially inner side so that the stator teeth protrude radially outwards. The plastic member separates the stator teeth electrically from each other. The ring-shaped plastic member can be made as a separate part, wherein the separate stator teeth are form-fitted to the ring-shaped plastic part. The stator teeth can alternatively be overmolded by the plastic part.

The fact that the stator teeth are attached together by the plastic member to a mounting unit simplifies the mounting of the stator teeth at the ring-shaped magnetic back iron ring, wherein all stator teeth can be attached to the magnetic back iron ring in only one step.

In an embodiment of the present invention, the auxiliary unit can, for example, be provided with a centrifugal pump rotor which is co-rotatably fixed to the motor rotor. The auxiliary unit can, for example, be an electric coolant pump which is used for the coolant supply to cool an engine or components of a motor vehicle. The auxiliary unit can, for example, comprise a separating can that is arranged radially between the motor stator and the motor rotor. The separating can is substantially cylindrical and surrounds the motor rotor radially. The separating can separate the gas or fluid, for example, coolant, from the dry parts of the electric motor comprising the motor stator.

In an embodiment of the present invention, the motor housing can, for example, comprise a first housing element which defines a pump chamber, a second housing element which defines a motor chamber, and a third housing element which defines an electronic chamber, wherein the separate ring-shaped magnetic back iron ring is overmolded by the second element of the plastic motor housing. In the assembled state, the first housing element is attached to a first front end of the second housing element and the third housing element is attached to a second front end. The fastenings between the housing elements are, for example, made by screws. By separating the motor housing, the manufacture thereof can be simplified since the overmolding of the magnetic back iron ring is done exclusively by the second housing element.

The present invention also provides a method for manufacturing an electric motor comprising a motor housing and a stator with several stator teeth and a separate ring-shaped magnetic back iron ring. The method comprises the following steps:
Overmolding the ring-shaped magnetic back iron ring by the stator housing;
and
Attaching the stator teeth to the ring-shaped magnetic back iron ring.

Advantages of the method are set forth above.

An embodiment of the present invention is described in greater detail below under reference to the enclosed drawings.

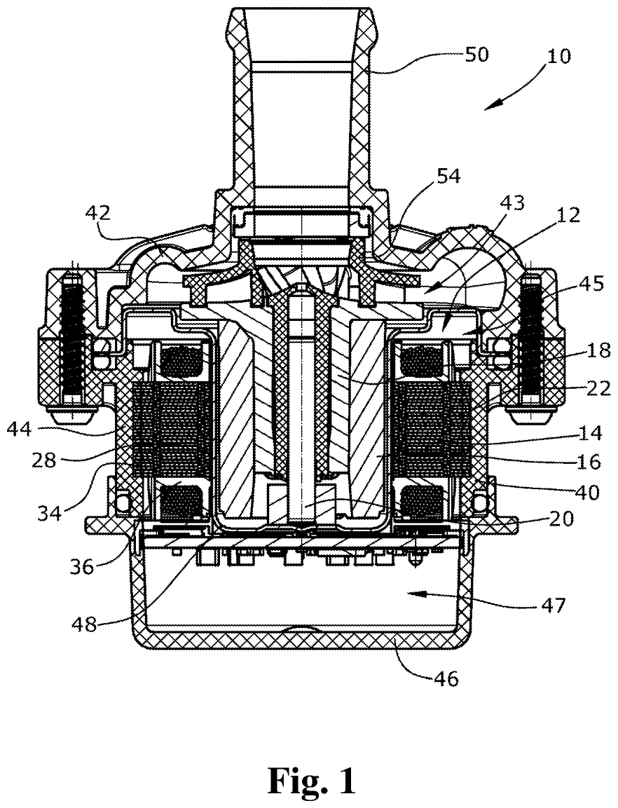

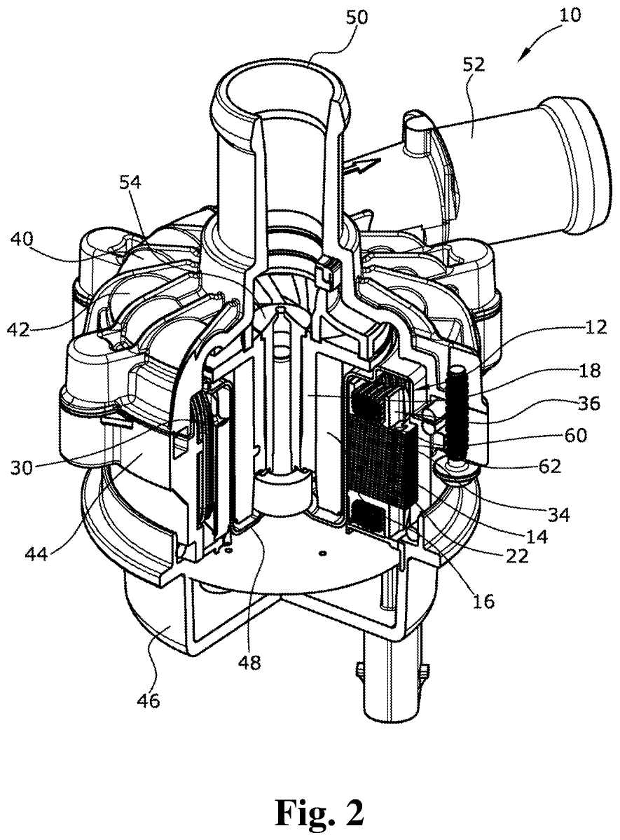

FIGS. 1 and 2 shows an automotive auxiliary unit 10 which is designed as a coolant pump. The automotive auxiliary unit 10 is provided with an electric motor 12 comprising a static motor stator 14, a rotatable motor rotor 16 with a rotor body 18, and a permanent magnet attached to the rotor body 18.

The motor rotor 16 rotates around a rotor axis 20, wherein the motor rotor 16 is supported by bearings that axially and radially position the motor rotor 16. A pump rotor 54 is attached to the motor rotor 16.

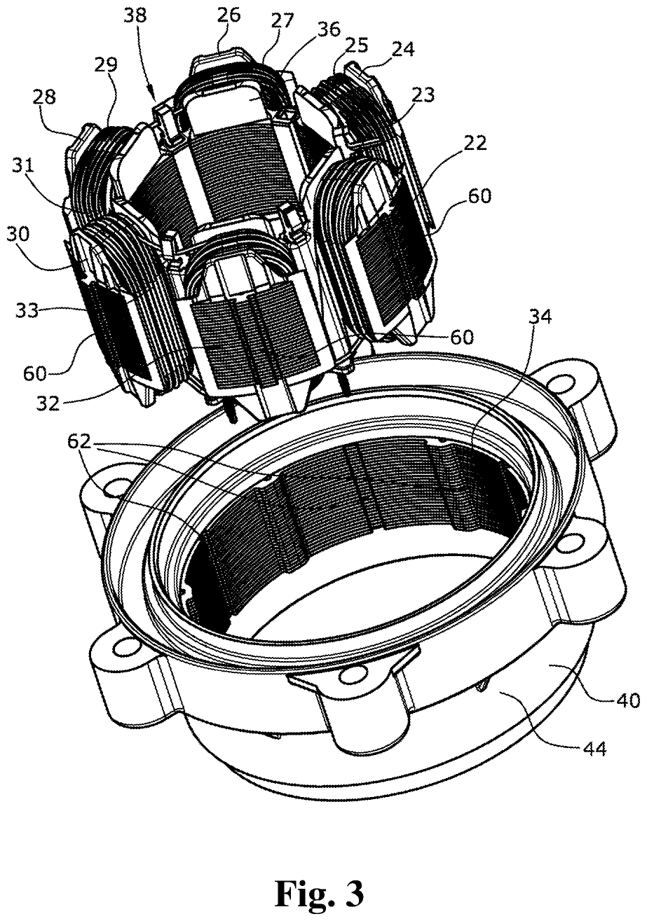

The motor stator 14 is formed by six stator teeth 22, 24, 26, 28, 30, 32, which are all shown in FIG. 3, and a separate magnetic back iron ring 34. Each of the stator teeth 22, 24, 26, 28, 30, 32 comprise a sheet pack that consists of a plurality of identical stator sheets, wherein the sheets are stacked together by die-cut stacking. The stator teeth 22, 24, 26, 28, 30, 32 are undetachably fastened to the plastic member 36 so that the six stator teeth 22, 24, 26, 28, 30, 32 and the plastic member 36 are assembled as one mounting unit 38. The plastic member 36 is ring-shaped and connects the stator teeth 22, 24, 26, 28, 30, 32 on the radially inner side. The plastic member 36 separates the stator teeth 22, 24, 26, 28, 30, 32 magnetically from each other. Each of the stator teeth 22, 24, 26, 28, 30, 32 comprises a winding forming an electromagnetic stator coil 23, 25, 27, 29, 31, 33.

The separate magnetic back iron ring 34 radially surrounds the stator teeth 22, 24, 26, 28, 30, 32, wherein the separate magnetic back iron ring 34, the stator teeth 22, 24, 26, 28, 30, 32 comprising the plastic member 36, and the electromagnetic stator coils 23, 25, 27, 29, 31, 33 form the motor stator 14.

The automotive auxiliary unit 10 is also provided with a motor housing 40 which is also a pump housing. The substantially cylindrical motor housing 40 comprises a first housing element 42, a second housing element 44, and third housing element 46. The first housing element 42 and the third housing element 46 are pot-shaped. The second housing element 44 is ring-shaped. The first housing element 42 is attached to the second housing element 44 by several screws. The third housing element 46 is attached to the second housing element 44. The first housing element 42 defines a pump chamber 43. The second housing element 44 defines a motor chamber 45. The third housing element 46 defines an electronics chamber 47. A separating can 48 fluidically separates the pump chamber 43 from the motor chamber 45. The first housing element 42 is provided with an axial pump inlet 50 and with a radial pump outlet 52.

According to the present invention, the separate magnetic back iron ring 34 is overmolded by the motor housing 40, in particular by the second housing element 44. The separate magnetic back iron ring 34 is attached to the mounting unit 38 by a dovetail connection, wherein the stator teeth 22, 24, 26, 28, 30, 32 each comprise a dovetail-shaped protrusion 60 and the separate magnetic back iron ring 34 comprises several grooves 62 corresponding to the dovetail-shaped protrusions 60.

In the coolant pump manufacturing process, the mounting unit 38 with the stator teeth 22, 24, 26, 28, 30, 32, the plastic member 36, and the electromagnetic stator coils 23, 25, 27, 29, 31, 33, is produced. At the same time, the motor housing 40 is produced via an injection molding process. During the injection molding process of the second housing element 44, the separate magnetic back iron ring 34 of the motor stator 14 is overmolded by the plastic of the second housing element 44. The separate magnetic back iron ring 34 is thereby form-fitted to the second housing element 44 in a radial, tangential and axial direction. The mounting unit 38 is then pushed axially into the separate magnetic back iron ring 34, wherein the dovetail-like protrusions 60 are pressed into the grooves 62. The mounting unit 38 is thereby axially press-fitted to the separate magnetic back iron ring 34 and is radially and tangentially form-fitted to the separate magnetic back iron ring 34. The separating can 48 is then installed, the motor rotor 16 comprising the pump rotor 54 is mounted, and the housing elements 42, 44, 46 of the motor housing 40 are joined together.

This kind of manufacturing of the automotive auxiliary unit 10 reduces the production effort, wherein the additional step in which the motor stator 14 is attached to the motor housing 40 is no longer required.

The present invention is not limited to embodiments described herein; reference should be had to the appended claims.

### LIST OF REFERENCE NUMERALS

10 Automotive auxiliary unit
12 Electric motor
14 Motor stator
16 Motor rotor
18 Rotor body
20 Rotor axis
22 Stator tooth
23 Electromagnetic stator coil
24 Stator tooth
25 Electromagnetic stator coil
26 Stator tooth
27 Electromagnetic stator coil
28 Stator tooth
29 Electromagnetic stator coil
30 Stator tooth
31 Electromagnetic stator coil
32 Stator tooth
33 Electromagnetic stator coil
34 Separate magnetic back iron ring
36 Plastic member
38 Mounting unit
40 Motor housing
42 First housing element
43 Pump chamber
44 Second housing element
45 Motor chamber
46 Third housing element
47 Electronics chamber
48 Separating can
50 Axial pump inlet
52 Radial pump outlet
54 Pump rotor
60 Dovetail-like protrusions
62 Groove

What is claimed is:

1-10. (canceled)

11. An automotive electric auxiliary unit comprising an electric motor, the electric motor comprising:
a rotatable motor rotor which is configured to rotate about a rotor axis;
a multi-piece motor stator comprising a plurality of stator coils, a plurality of stator teeth, and a separate ring-shaped magnetic back iron ring, wherein the separate ring-shaped magnetic back iron ring is arranged to radially surround the plurality of stator teeth and is attached to the plurality of stator teeth; and
a plastic motor housing,
wherein,
the separate ring-shaped magnetic back iron ring is overmolded by the plastic motor housing.

12. The automotive electric auxiliary unit as recited in claim 11, wherein the plastic motor housing is produced via an injection molding.

13. The automotive electric auxiliary unit as recited in claim 11, wherein the plurality of stator teeth are attached to the separate ring-shaped magnetic back iron ring by at least one of a form-fit connection and a force-fit connection.

14. The automotive electric auxiliary unit as recited in claim 13, wherein the form-fit connection is a dovetail connection which is provided by a plurality of dovetail-like protrusions being press-fitted into a plurality of corresponding grooves.

15. The automotive electric auxiliary unit as recited in claim 11, wherein,
the electric motor further comprises a plastic member, and
the plurality of stator teeth are attached to each other via the plastic member.

16. The automotive electric auxiliary unit as recited in claim 15, wherein,
the electric motor further comprises a mounting unit,
the plurality of stator teeth and the plastic member are fastened to the mounting unit, and
the plurality of stator teeth are form-fitted and undetachably fastened to the plastic member.

17. The automotive electric auxiliary unit as recited in claim 11, further comprising:
an auxiliary unit comprising a centrifugal pump rotor which is co-rotatably fixed to the rotatable motor rotor of the electric motor.

18. The automotive electric auxiliary unit of as recited in claim 17, wherein the auxiliary unit is an electric coolant pump.

19. The automotive electric auxiliary unit as recited in claim 11, wherein,
the plastic motor housing comprises a first housing element which defines a pump chamber, a second housing element which defines a motor chamber, and a third housing element which defines an electronic chamber, and
the separate ring-shaped magnetic back iron ring is overmolded by the second element of the plastic motor housing.

20. A method for manufacturing an electric motor, wherein the electric motor comprises,
a plastic motor housing, and
a motor stator comprising a plurality of stator teeth and a separate ring-shaped magnetic back iron ring,
the method comprising:
overmolding the separate ring-shaped magnetic back iron ring by the plastic motor housing; and
attaching the plurality of stator teeth to the separate ring-shaped magnetic back iron ring.
